(19) United States
(12) Patent Application Publication
(10) Pub. No.: US 2018/0196870 A1
(43) Pub. Date: Jul. 12, 2018

(54) SYSTEMS AND METHODS FOR A SMART SEARCH OF AN ELECTRONIC DOCUMENT

(71) Applicant: Microsoft Technology Licensing, LLC, Redmond, WA (US)

(72) Inventor: Kaustav Mukherjee, Kolkata West Bengal (IN)

(73) Assignee: Microsoft Technology Licensing, LLC, Redmond, WA (US)

(21) Appl. No.: 15/404,596

(22) Filed: Jan. 12, 2017

(51) Int. Cl. G06F 17/30; G06F 17/27

(52) U.S. Cl. CPC G06F 17/30675; G06F 17/278; G06F 17/30646; G06F 17/30011; G06F 17/2705

(57) ABSTRACT

Systems and methods for electronic document smart searching are provided. The systems and method for electronic document smart searching are capable of searching an electronic document based on query contexts and action patterns extracted from the query contexts. The systems and methods for electronic document smart searching parse a received query to determine keywords, contexts, action patterns, and/or nouns within the query. The systems and methods for electronic document smart searching match any identified keywords, contexts, action patterns, and/or nouns to elements in text and/or retrieved annotated data for the electronic document to determine search results (or desired passages) from the electronic document in response to the query.

### BACKGROUND

Searching within an electronic document, such as an ebook, is very common. These search systems are linear and unambiguous. For example, a search for the text “hello” will pull all instances in the document where the word “hello” is recited. Because of this linearity, these search systems can only pull passages from an electronic document that include a recitation of an exact word from the search query.

It is with respect to these and other general considerations that aspects disclosed herein have been made. Also, although relatively specific problems may be discussed, it should be understood that the aspects should not be limited to solving the specific problems identified in the background or elsewhere in this disclosure.

### SUMMARY

In summary, the disclosure generally relates to systems and methods for electronic document smart searching. The systems and method for electronic document smart searching are capable of searching an electronic document based on query contexts and/or action patterns extracted from the query contexts. The systems and methods for electronic document smart searching parse a received query to determine keywords, contexts, action patterns, and/or nouns within the query. The systems and methods for electronic document smart searching match any identified keywords, contexts, action patterns, and/or nouns to elements in the text or retrieve annotated data for the electronic document to determine search results (or desired passages) from the electronic document in response to the query. The ability of the systems and methods described herein to search an electronic document based on query contexts and/or action patterns extracted from query contexts improves the usability, improves the search capabilities, and/or improves user interactions of/with an electronic document search system.

One aspect of the disclosure is directed to a system for ebook smart searching. The system includes at least one processor and a memory. The memory encodes computer executable instruction that, when executed by the at least one processor, are operative to:
receive a notification of a loaded first ebook;
collect annotated data for the first ebook;
receive a first query for the first ebook;
parse the first query utilizing a knowledge graph and a dictionary to form a revised query;
search the annotated data and text of the first ebook for keywords that match the identified keywords;
identify one or more relevant passages based on the keywords in the ebook that match the identified keywords;
search the annotated data of the one or more relevant passages for any story action patterns that match the query action pattern;
identify one or more potential passages from the one or more relevant passages based on the story action patterns that match the query action pattern;
search for the nouns in the one or more potential passages;
determine one or more result passages based on the search for the nouns in the one or more potential passages; and
provide the one or more result passages to the user in response to the first query.
The parsing of the first query includes identifying elements in the first query, identifying a replaceable element in the elements, replacing the replaceable element with a corresponding collocation, assigning a context to at least one identified keyword in the first query, identifying a query action pattern for the context, and identifying nouns in the first query. The identified keywords include the corresponding collocation and remaining elements from the elements.

In yet another aspect of the invention, the disclosure is directed to a system for ebook smart searching. The system includes at least one processor and a memory. The memory encodes computer executable instruction that, when executed by the at least one processor, are operative to:
receive a notification of a loaded ebook;
collect annotated data for the ebook;
receive a query for the ebook;
parse the query utilizing at least one of a knowledge graph and a dictionary to form a revised query;
search the annotated data of the ebook for the keywords;
identify one or more relevant passages based on the search for the keywords;
search the annotated data of the one or more relevant passages for any story action patterns that match the query action pattern;
identify one or more potential passages from the one or more relevant passages based on the story action patterns that match the query action pattern;
identify one or more result passages from the one or more potential passages; and provide the one or more result passages in response to the query.
Parsing of the query includes identifying elements in the query, identifying replaceable elements in the elements, replacing the replaceable elements with collocations, assigning a context to at least one keyword of keywords in the query, and identifying a query action pattern for the context

In another aspect, a method for electronic document smart searching is disclosed. The method includes:
receiving a notification of a loaded electronic document, wherein the electronic document contains at least a predetermined amount of data;
collecting annotated data for the electronic document;
receiving a query for the electronic document;
parsing the query utilizing a knowledge graph and a dictionary to form a revised query;
identifying one or more relevant passages from the electronic document based on a search for keywords from the revised query;
searching the annotated data of the one or more relevant passages and identifying story action patterns that match a query action pattern from the revised query;
identifying one or more potential passages from the one or more relevant passages based on the story action patterns that match the query action pattern;
identifying one or more result passages from the one or more potential passages; and
sending the one or more result passages in response to the query.
The parsing of the query comprises utilizing dependency parsing and part-of-speech tagging.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive embodiments are described with reference to the following Figures.

FIG. 1 is a schematic diagram illustrating a smart search system on a client computing device, in accordance with aspects of the disclosure.

FIG. 2 is a schematic diagram illustrating a smart search system on a server computing device being utilized by a user via a client computing device, in accordance with aspects of the disclosure.

FIG. 3 is a schematic diagram illustrating a smart search system on a server computing device being utilized by a user via a client computing device, in accordance with aspects of the disclosure.

FIG. 4A is a block flow diagram illustrating a method for electronic document smart searching, in accordance with aspects of the disclosure.

FIG. 4B is a block flow diagram illustrating the parsing operation for the method shown in FIG. 4A, in accordance with aspects of the disclosure.

FIG. 5 is a block diagram illustrating example physical components of a computing device with which various aspects of the disclosure may be practiced.

FIG. 6A is a simplified block diagram of a mobile computing device with which various aspects of the disclosure may be practiced.

FIG. 6B is a simplified block diagram of the mobile computing device shown in FIG. 6A with which various aspects of the disclosure may be practiced.

FIG. 7 is a simplified block diagram of a distributed computing system in which various aspects of the disclosure may be practiced.

FIG. 8 illustrates a tablet computing device with which various aspects of the disclosure may be practiced

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the spirit or scope of the present disclosure. The following detailed description is therefore not to be taken in a limiting sense, and the scope of the present disclosure is defined by the claims and their equivalents.

As discussed above, searching within an electronic document, such as an ebook, is very common. These search systems are linear and unambiguous. For example, a search for the text “goodbye” will pull all instances in the document where the word “goodbye” is recited. Because of this linearity, these search systems can only pull passages from an electronic document that include a recitation of an exact word from a query. However, there are several other phrases and words that also mean goodbye, such as, “see you later,” “adios,” “Godspeed,” “adieu,” “cheerio,” “ciao,” “so long,” “toodles,”etc. While these words and phrases also represent a type of a “goodbye,” these words and phrases would not be pulled by currently utilized search systems. Users often need to search not by word, but by context. The user may have performed a search for the word “goodbye,” but the user actually wants to know each instance where a person or character parts from another person or character. The currently utilized search systems are not capable of searching for the parting between characters in an electronic document based on search of the term “goodbye.”

As such, while currently utilized search systems for an electronic document search for the exact terms recited in a query in an electronic document, these search tools are not capable of searching for action patterns extracted from the query contexts in an electronic document. Further, the currently utilized search systems are not capable of determining or finding action patterns within the electronic document.

Therefore, systems and methods for electronic document smart searching are disclosed herein. The systems and methods for electronic document smart searching are capable of searching an electronic document based on query contexts and action patterns extracted from the query contexts. The systems and methods for electronic document smart searching parse a received query to determine keywords, contexts, action patterns, and/or nouns within the query. The systems and methods for electronic document smart searching match any identified keywords, contexts, action patterns, and/or nouns to elements in the text and/or retrieved annotated data for the electronic document to determine search results (or desired passages) from the electronic document in response to the query. The ability of the systems and methods described herein to search an electronic document based on query contexts and/or action patterns extracted from the query contexts improve the usability, improves the search capabilities, and/or improves user interactions of/with an electronic document search system.

For example, a user may input the following query, “Bruce Wayne having a war of words with Joker.” The previous utilized electronic document search systems would find and pull every instance where the terms, “Bruce Wayne,” “war” “words” and “Joker” are listed. In contrast, the systems and methods as disclosed herein will search for each time Bruce Wayne or Batman have a conversation by matching action patterns for a conversation between these two characters within the electronic document. While this may seem similar to what search engines like Google or Bing do, these search engines index and search content by the actual content, and are limited to user metadata like page rank, relevance of query to content (i.e., “Maria Sharapova” might bring up Wikipedia as the first link, but “Maria Sharapova kiss” might bring up The Daily Mail as the first result, even though the major term in both queries is Maria Sharapova). But both search results actually have to have the term “Maria Sharapova”, and/or “kiss.” As such, a search engine is also not capable of finding each instance of a conversation action pattern based on the context of a query. As such, the systems and method as described herein provide an effective search system that can search and find passages in an electronic document with action patterns and/or context that match query contexts and action patterns extracted from the query contexts unlike previous electronic search systems.

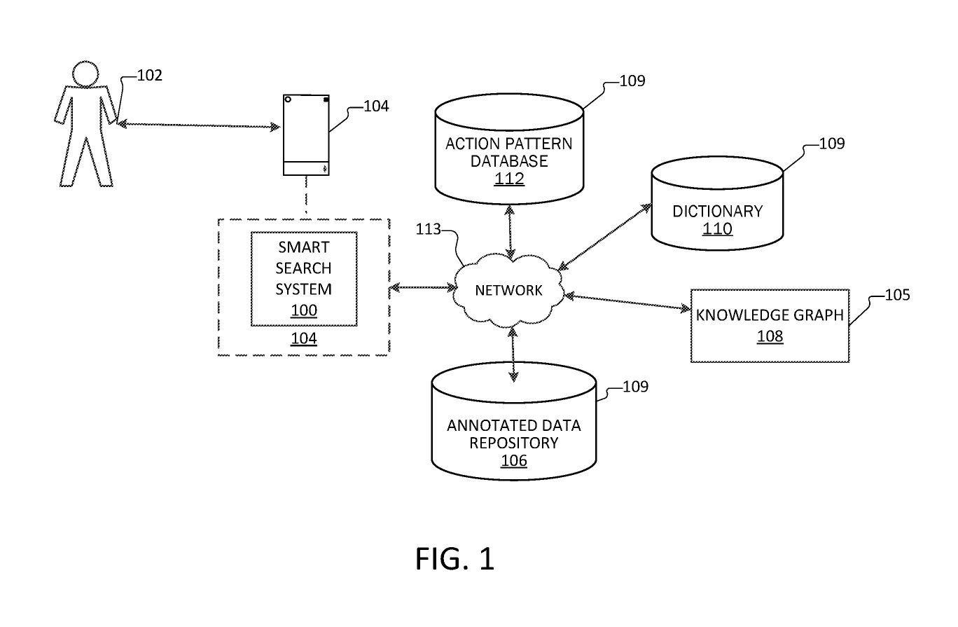

FIGS. 1-3 illustrate different examples of a smart search system 100 for an electronic document. The smart search system 100 is a system for searching an electronic document that is capable of searching an electronic document based on query contexts and any action patterns extracted from the query contexts. The smart search system 100 parses a received query to determine keywords, contexts, action patterns, and/or nouns within the query. The smart search system 100 matches any identified keywords, contexts, action patterns, and/or nouns to elements in text and/or retrieved annotated data for the electronic document to determine search results (or desired passages) from the electronic document in response to the query. The ability of the systems and methods described herein to search an electronic document based on query contexts and/or action patterns extracted from the query contexts improves the usability, improves the search capabilities, and/or improves user interactions of/with an electronic document search system.

In some aspects, smart search system 100 is implemented on the client computing device 104 as illustrated in FIG. 1. In a basic configuration, the client computing device 104 is a computer having both input elements and output elements. The client computing device 104 may be any suitable computing device for implementing smart search system 100. For example, the client computing device 104 may be a mobile telephone, a smart phone, a tablet, a phablet, a smart watch, a wearable computer, a personal computer, a gaming system, a desktop computer, a laptop computer, and/or etc. This list is exemplary only and should not be considered as limiting. Any suitable client computing device 104 for implementing smart search system 100 may be utilized.

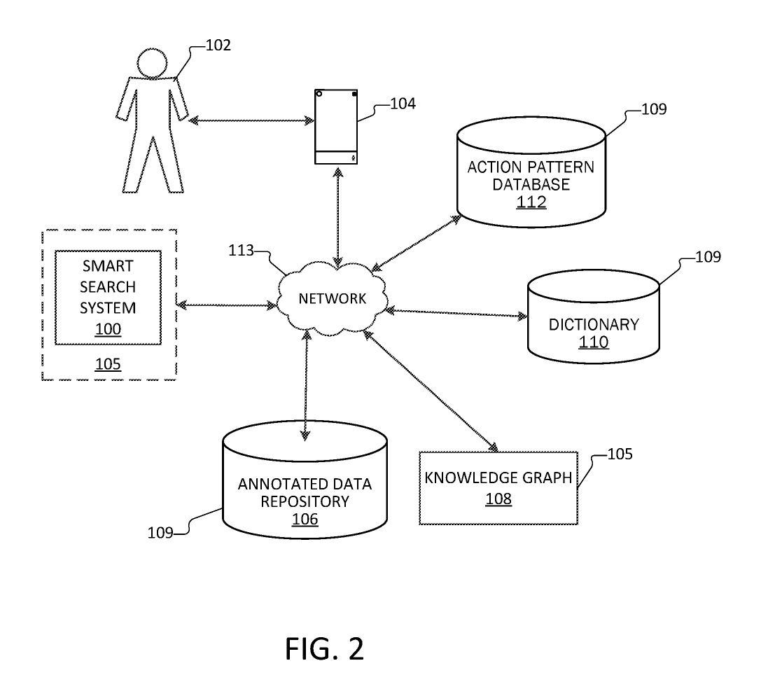

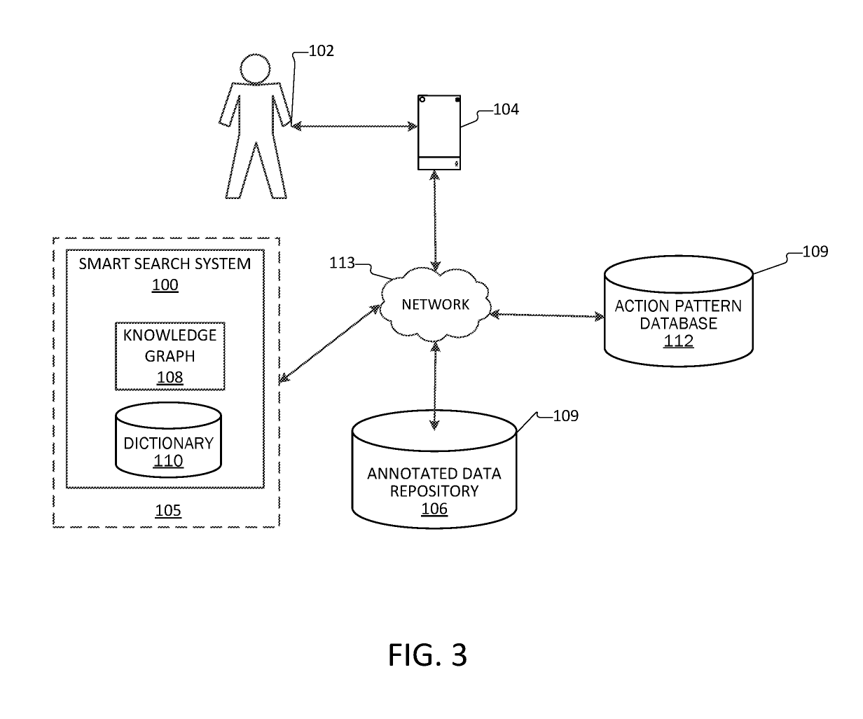

In other aspects, smart search system 100 is implemented on a server computing device 105, as illustrated in FIGS. 2-3. The server computing device 105 may provide data to and/or receive data from the client computing device 104 through a network 113. In some aspects, the network 113 is a distributed computing network, such as the internet. In further aspects, that smart search system 100 is implemented on more than one server computing device 105, such as a plurality or network of server computing devices 105. In some aspects, smart search system 100 is a hybrid system with portions of smart search system 100 on the client computing device 104 and with portions of smart search system 100 on the server computing device 105.

The smart search system 100 collects a notification that a client computing device 104 has downloaded or retrieved an electronic document. In response to this notification, the smart search system 100 collects annotated data for the electronic document. The term “collect” as utilized herein refers to the active retrieval of information and/or the passive receiving of information. The smart search system 100 may collect the annotated data from an annotated data repository 106. In some aspects, the smart search system 100 includes an annotated data repository 106. In alternative aspects, the smart search system 100 does not include an annotated data repository 106 but communicates with the annotated data repository 106 through a network 113 as illustrated in FIGS. 1-3. The annotated data repository 106 may be or include one or more databases 109. The annotated data repository 106 as utilized herein is one or more databases 109 that store annotated data from one or more electronic documents. The smart search system 100 is not effective unless annotated for the electronic document can be retrieved. Action patterns and/or user contexts are only detectable in the electronic document by the smart search system 100 if there is annotated data for the electronic document. If there is no annotated data for the electronic document, the smart search system 100 is limited to the linear, unambiguous text search as performed by the previously utilized search systems.

In some aspects, the annotated data is heavily rich. For example, annotated data for three different one-on-one conversations for an electronic document is listed below:

| | |
|---|---|
| (1) | Kelly <human - Kelly - female>: <dialogue>Is this a |
| | dream?</dialogue> John<human - John - |
| | male>:<dialogue>Much better than a dream. It is a dream |
| | which we can share.</dialogue> Kelly <human - Kelly - |
| | female>: <dialogue>By why Paris? </dialogue> |
| | John<human - John - male>: <dialogue>Because it is the |
| | most romantic place on earth. </dialogue>; |
| (2) | Kelly<human - Kelly - female> asked <dialogue>“Is this a |
| | dream?”</dialogue>. John<human - John - Male> |
| | said<dialogue>“Much better than a dream. It is a dream which |
| | we can share.”</dialogue>. She<human - Kelly - female> |
| | asked, <dialogue>“By why Paris?”</dialogue>. John<human - |
| | John - Male>replied <dialogue>“Because it is the most |
| | romantic place on earth”</dialogue>; and |
| (3) | Kelly<human - Kelly - female> asked “Is this a dream?” |
| | <noise between dialogues>John<human - John - Male> |
| | thought hard how to give a romantic reply that won't come as |
| | flirting. A semi - cheesy line, may be? Nope. Something better, |
| | kinda classy.</noise between dialogues> “Much better than a |
| | dream” he<human - John - Male> said, “It is a dream which |
| | we can share.”. <noise between dialogues>Wow, |
| | Kelly<human - Kelly - female> thought. He<human - John - |
| | Male> is one cool flirt.</noise between dialogues> “But |
| | why Paris”, she<human - Kelly - female> asked. <noise |
| | between dialogues>This time the answer was instantaneous - |
| | </noise between dialogues> “Because it is the most romantic |
| | place on earth” <implied - human - John - Male>. |

Further, the smart search system 100 requires that the electronic document include at least a minimum amount data for effective searching. Action patterns and user contexts are only detectable in an electronic document by the smart search system 100 if there is a minimum amount of data in the electronic document. If an electronic document does not contain the minimum amount of data, the smart search system 100 will not be able to determine and identify action patterns from the annotated data of the electronic document and will have to rely on exact text matching for searching. As such, the smart search system 100 may be utilized for ebooks, which are likely to have been previously annotated and to meet the minimum amount data required for effective searching. The example provided above is not limiting. As understood by a person of skill in the art, the smart search system 100 may be utilized with any electronic document that meets the minimum data requirement and that has accessible annotated data.

The smart search system 100 receives a query from the user 102. The query may be received from the client computing device 104 or from user input into the client computing device 104. The smart system 100 parses the query utilizing a knowledge graph 108 and/or dictionary 110 to form a revised query. In some aspects, the smart system 100 utilizes dependency parsing and/or part-of-speech tagging to parse the query to form the revised query.

The smart system 100 parses the query by identifying any elements in the query that are replaceable and then replacing any identified replaceable elements with a corresponding collocation. The elements include any term or phrase listed in the query or any identified or inferred terms, phases, or keywords from the query determined utilizing a knowledge graph 108, dictionary 110, and/or dependency parsing. Because English is a fairly complicated language, English contains a number of idioms that use a combination of words to convey a meaning that has absolutely nothing to do with the individual words themselves. For example, “war of words” has nothing to with two words having a war, but instead refers to two people having a heated debate. As such, the smart system 100 identifies the phrase, “war of words” as a replaceable element utilizing a dictionary 110 and/or a knowledge graph 108. The dictionary 110 is one or more databases 109 of words and idioms where words and idioms are correctly mapped to simple contextual outcomes. For example, the contextual mapping for the phrase, “give of gab” is provided below:

Gift of the gab: [<indi - adj>fluent</indi> <indi - noun, synset -
say>speaker</indi>], [<relation>person</relation>], [<positive>]
[<usage>[{person} has <>, {person} is blessed with <>, {person}
is known for <>, {person}'s famed <></usage>], [{person} - >
<>].

The list above may be dynamic. In other words, as more usages are discovered, the list will keep on getting updated to cover the complete gamut of possible usages. The actions listed above may be attributed to the any person involved. Another example illustrating the contextual mapping for the phrase, “war of words” is provided below:

War of words: [<indi -adj, synset - argument weak>heated</indi>
<indi-adj >debate</indin>], [<relation>(n) persons],
[<usage>[{person}s having a <>, <> between {person}s], [persons
=> <>]

In some aspects, the smart search system 100 includes the dictionary 110 as illustrated in FIG. 3. In alternative aspects, the smart search system 100 does not include the dictionary 110 but communicates with the dictionary 110 through a network 113 as illustrated in FIGS. 1-2.

Once the smart search system 100 has identified a replaceable element utilizing the dictionary 110, the smart search system 100 replaces the replaceable element with a collocation from the dictionary 110 and/or knowledge graph 108. The “collocation” as utilized herein is a contextual mapping or contextual outcome collected from the dictionary 110 and/or knowledge graph 108. For example, the query discussed above, “Bruce Wayne having a war of words with Joker,” is modified as follows: “Bruce Wayne having a<collocation—war of words>with Joker.” In this example, the “<collocation—war of words>” represents the contextual mapping listed above.

The knowledge graph 108 and/or the dictionary 110 may be semi-supervised. As such, the knowledge graph 108 and/or the dictionary 110 may be updated or modified based on the collected annotated data from the electronic document. For example, the smart search system 100 utilizing the semi-supervised data from the electronic document and a general knowledge graph 108 can determine that Bruce Wayne can be exchanged with Batman without loss of meaning. As such, the smart system 100 identifies “Bruce Wayne” as replaceable element and replaces this element with the collocation of “Bruce Wayne or Batman.”

As utilized herein, “part-of-speech tagging” includes identifying replaceable elements in the query and replacing the identified elements with their corresponding collocations from the dictionary 110 and/or knowledge graph 108 as discussed above.

The modified query now contains identified elements and collocations, which have replaced some of the identified elements. The remaining identified elements and the collocations in the query are referred to herein as the keywords or the identified keywords of the query. The remaining identified elements are any elements that have not been replaced by a collocation in the modified query.

Utilizing the knowledge graph 108, the smart search system 100 dependency parses the query to identify or assign contexts for/to one or more the keywords in the query. The context may include relationships between one or more of the keywords in the query, identification of an activity associated with one or more of the keywords in the query, and/or identification of nouns based on the one or more keywords in the query. For example, for the modified query discussed above: “<collocation—Bruce Wayne>having a <collocation—war of words>with Joker,” the smart search system 100 can determine utilizing a semi-supervised dictionary 110 and/or knowledge graph 108 that the element “collocation—war of words” belongs to two elements of the query: 1) Bruce Wayne; and 2) Joker. Additionally, the smart search system 100 utilizing the semi-supervised data from the electronic document and a general knowledge graph 108 can determine that Batman, Bruce Wayne, and the Joker are all persons. Further, the smart search system 100 can determine or identify that the collocation of war of words is an activity. Accordingly, the smart system 100 parses the query, “Bruce Wayne having a war of words with Joker,” utilizing a semi-supervised dictionary 110 and knowledge graph 108 to form the revised query listed below:
<person-count[2][Bruce Wayne, Joker]-activity[debate]>.

In response to the identification of an activity (or context) in the query by the smart search system 100, the system 100 searches for and collects an action pattern that corresponds to the identified activity (or context) from an action pattern database 112. In other words, the smart search system 100 identifies an action pattern that corresponds to the identified activity from the action pattern database 112. The action pattern database 112 is one or more database of stored action patterns that correspond to one or more activities. In some aspects, the smart search system 100 includes an action pattern database 112. In alternative aspect, smart search system 100 does not include an action pattern database 112 but communicates with the action pattern database 112 through a network 113 as illustrated in FIGS. 1-3. An action pattern that corresponded to an activity or context in the search query may be referred to herein as “query action pattern.”

In some aspects, the smart search system 100 dependency parses the query to identify nouns in the query. The nouns of the revised query listed above include Bruce Wayne and Joker. Further, an inferred noun of Batman determined based on the semi-supervised knowledge graph 108 and/or dictionary 110 is also identified. The smart search system 100 may not be able to identify any nouns and/or collocations depending upon the received query. In these aspects, while the smart search system 100 will attempt to identify replaceable elements and/or nouns, the smart search system 100 will not be able to identify any replaceable elements and/or nouns.

Once the query has been revised, the smart search system 100 searches the text and/or the collected annotated data of the electronic document for the identified keywords. The smart search system 100 identifies one or more relevant passages based on the identified keywords. In some aspects, the smart search system 100 identifies one or more relevant passages by pulling passages that have text that match or have annotated data that match the one or more identified keywords from the search query.

Next, the system 100 searches the text and/or the collected annotated data of the one or more relevant passages for any identified query action patterns. The smart search system 100 identifies one or more potential passages from the relevant passages based on the search for the query action pattern in the relevant passages. In some aspects, the smart search system 100 searches the text and/or the collected annotated data of the relevant passages for the query action pattern by searching for story action patterns in the text and/or the collected annotated data of the relevant passages that match the query action pattern. The story action patterns as utilized herein refer to action patterns located within electronic document. In these aspects, the smart search system 100 identifies one or more potential passages from the relevant passages based on passages that contain any story action patterns that match the query action pattern.

In further aspects, the story action pattern does not have to 100% match to the query action pattern because the smart search system 100 may be able to account for noise in the story action pattern. For example, for a one-on-one conversation preconfigured action pattern, the story action pattern will often contain some unstructured content during one-on-one conversation. This unstructured content may be discounted as noise by the smart search system 100. Unstructured content may be considered noise by the smart search system 100 when both sides of the noise have the same set of people talking during a conversation preconfigured action pattern. For example, during a conversation between Batman and the Joker in an ebook, there may be sentences that describe physical action of the characters during the conversation, such as in Passage 1 listed below:
Batman yells: “Give it up Joker, you are surrounded.” After speaking, Batman scans his peripheral vision for the Joker's associates. Joker snickers, “Never!”
   The smart search system 100, will be able to identify the unstructured content (or the portion of the passage that does not match the structure of a one-on-one conversation) of “After speaking, Batman scans his peripheral vision for the Joker's associates,” as noise and still pull the above passage in response to the query discussed above of, “Bruce Wayne having a war of words with Joker.”

If no nouns have been identified in the query, the smart search system 100 utilizes the one or more potential passages as the result passages. If one or more nouns have been identified, the smart search system 100 searches for the nouns in the text and/or annotated data of the one or more potential passages. In some aspects, the smart search system 100 searches for the nouns by trying to match the query nouns to nouns listed in the text or annotated data of the one or more potential passages. In these aspects, the one or more results passages are based on the search for the text and/or annotated data of the one or more query nouns in the text and/or annotated data of the one or more potential passages. In these aspects, if the identified nouns in the search query are not matched to any of the nouns in the one or more potential passages, the one or more result passages will be the same as the one or more potential passages. In some aspects, the smart search system 100 identifies the one or more results passages based on the nouns in the annotated data and/or text of the one or more relevant passages that match the one or more nouns identified in the query. For example, a query of “a war of words between Bruce Wayne and another character” would pull Passage 1 above, while a query of “a war of words between Batman and Alfred” would not pull Passage 1 above. The query of “a war of words between Batman and Alfred” would pull one-on-one conversations as potential passages, such as Passage 1, but Passage 1 above would be excluded from the result passages because the noun “Alfred” is not listed in Passage 1 as required by the second query.

Once the result passages have been determined, the smart search system 100 provides the one or more result passages to the user 102 in response to the received query. In some aspects, where smart search system 100 is not on the client computing device 104, the one or more result passages are provided to the user 102 by sending instructions to the client computing 104 to provide the one or more result passages to the user 102 in response to the query. The client computing device 104 may provide the one or more result passages to the user 102 via any known suitable output, such as voice output, image output, text output, video output, and/or etc. For example, the client computing device 104 may display the one or more result passages as text on a user interface.

The smart search system 100 collects any available annotated data for each electronic document downloaded by client computing device 104. Further, the smart search system 100 may be able to perform queries on any electronic document the smart search system 100 has retrieved the annotated data for even if the client device is not currently utilizing the downloaded electronic document. In other aspects, the smart search system 100 is only able to perform query searches for downloaded electronic documents that are currently opened in or in use by the client computing device 104.

Because the smart search system 100 replaces replaceable elements in the query with collocations, the result passages may not include any of the same terms as utilized in the query. As such, the smart search system 100 provides query context and/or query action pattern searching on an electronic document that improves the usability, improves the s search capabilities, and/or improves user interactions of/with an electronic document search system.

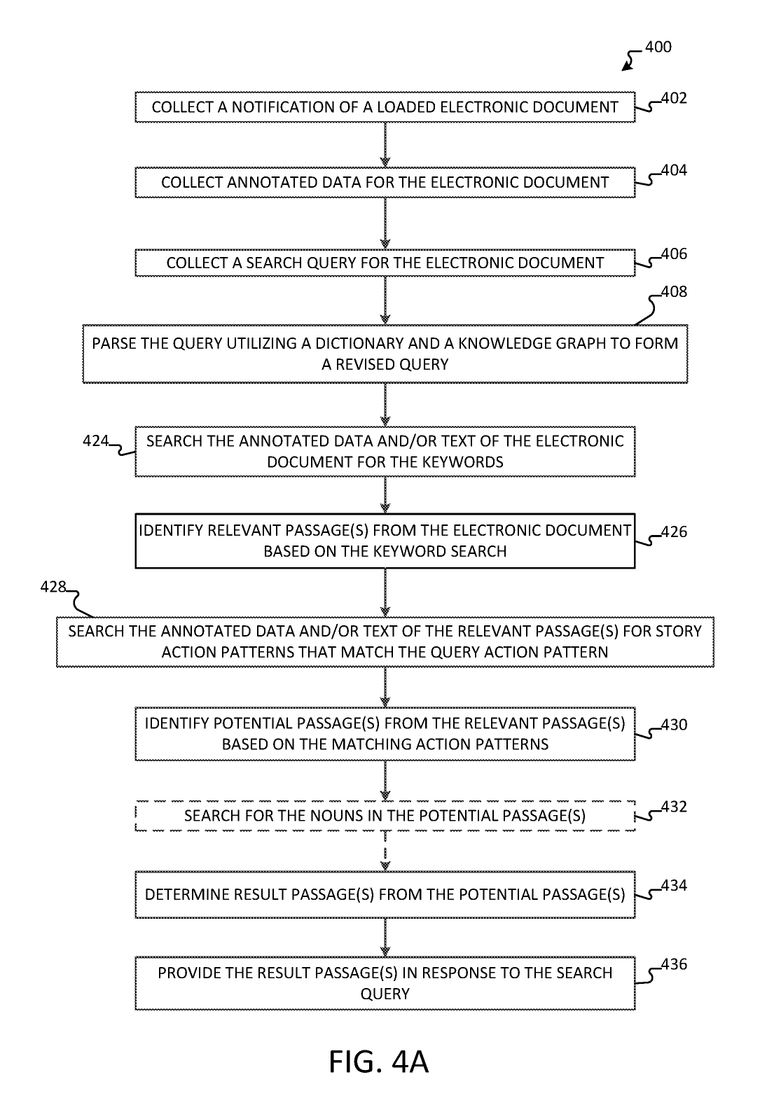

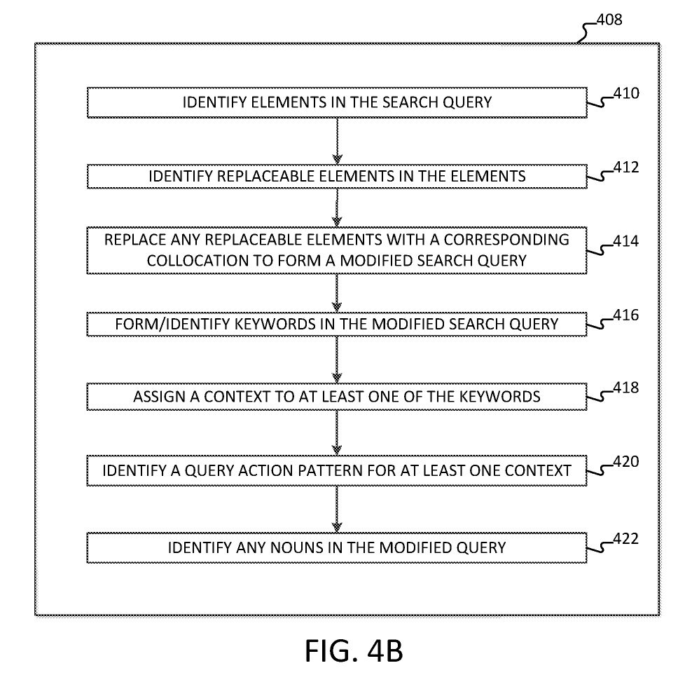

FIG. 4 illustrates a flow diagram conceptually illustrating an example of a method 400 for electronic document smart searching. In some aspects, method 400 is performed by smart search system 100 as described above. Method 400 provides context and/or action pattern searching on an electronic document that improves the usability, improves the search capabilities, and/or improves user interactions of/with an electronic document search system.

Method 400 starts at operation 402. At operation 402, a notification of a loaded electronic document is collected. In response to the notification, operation 404 is performed. At operation 404, annotated data for the electronic document is collected. Method 400 requires that annotated data exist for the electronic document and that the electronic document include at least a minimum amount data for effective searching. Action patterns and user contexts are only detectable in an electronic document by method 400 if there is a minimum amount of data in the electronic document and/or if there is accessible annotated data for the electronic document. If an electronic document does not contain the minimum amount of data and/or accessible annotated data, method 400 will not be able to determine and identify contexts and/or action patterns in the electronic document and will have to rely on exact text matching for searching. As such, the method 400 may be utilized for ebooks, which are likely to have been previously annotated and to meet the minimum data requirements for effective searching.

Method 400 also includes operation 406. At operation 406, a user query for the electronic document is collected. The query may be collected from user input into a client device. The input may any type of acceptable input for the client computing device, such as text input, voice input, voice input, video input, image input, etc.

In response to collecting the user query at operation 406, method 400 performs operation 408. At operation 408, the query is parsed utilizing a knowledge graph and/or dictionary. The knowledge graph and/or dictionary may be semi-supervised or updated based the collected annotated data. In some aspects, at operation 408 the query is parsed utilizing dependency parsing and/or part-of-speech tagging. FIG. 4B illustrates a flow diagram conceptually illustrating an example operation 408 of method 400. Operation 408 includes the performance of operation 410, operation 412 operation 414, operation 416, operation 418, operation 420, and operation 422 as illustrated by FIG. 4B.

At operation 410, elements are identified in the query. The elements may include any term or phrase of the query. The elements may be identified utilizing any known natural language processing techniques at operation 410. The elements may be identified utilizing the dictionary and/or the knowledge graph at operation 410.

In some aspects, part-of-speech tagging is the performance of operation 412, operation 414, and operation 416. At operation 412, replaceable elements of the elements are identified utilizing the dictionary and/or the knowledge graph. As discussed above, the dictionary and/or the knowledge graph may be updated or semi-supervised based on the annotated data. At operation 414, any identified replaceable elements in the search query are replaced with a corresponding collocation to form a modified search query. The modified search query is made of the collocations and any remaining elements from the identified elements. If no replaceable elements are identified at operations 412, then no collocations are added and no collocations are part of the modified query at operation 414. At operation 416, the keywords are identified or formed. The keywords are the collocations and any remaining elements from the identified elements that didn't get replaced by the collocations in the modified search query. In some aspects, the keywords are automatically formed or identified upon formation of the modified search query at operation 416.

In some aspects, dependency parsing is the performance of operation 418, operation 420, and/or operation 422. At operation 418, a context is assigned to one or more of the keywords identified or formed at operation 416 utilizing the dictionary and/or the knowledge graph. As discussed above, the dictionary and/or the knowledge graph may be updated or semi-supervised based on the annotated data. As also discussed above, a context includes relationships between one or more of the keywords in the modified query and/or the identification of an activity associated with one or more of the keywords in the modified query.

After the contexts have been assigned to the modified query at operation 418, operation 420 is performed. At operation 420, a query action pattern is identified for one or more of the assigned contexts. In some aspects, at operation 420, each context is searched for in an action pattern database. In these aspects, each context with a corresponding action pattern in the action pattern database is collected at operation 420. In these aspects, any collected action pattern is assigned to its corresponding context in the modified query at operation 420. If no action patterns are identified at operations 420, then no query action patterns are identified at operation 418.

Also during operation 408, operation 422 is performed. At operation 422, any nouns in the modified query are searched for and identified at operation 422. If any of the keywords are nouns in the modified query, these keywords are identified as nouns in the modified query at operation 422. If none of the keywords are nouns in the modified query, no nouns are identified the modified query at operation 422.

In response to the revised query being been formed at operation 408, operation 424 is performed. At operation 424, the annotated data and/or the text of the electronic document are searched for the identified keywords in the revised query. In some aspects, at operation 424, the identified keywords are matched to keywords in the annotated data and/or text of the electronic document.

Next, at operation 426, one or more relevant passages are identified in the electronic document based on the search for the identified keywords performed at operation 424. In some aspects at operation 426, the one or more relevant passages are the passages that included text or annotated data with keywords that match the identified keywords in the query.

After operation 426, operation 428 is performed. At operation 428, the annotated data and/or the text of the relevant passages identified at operation 426 are searched for the query action patterns. In some aspects at operation 428, the query action patterns are matched to story action patterns found in the annotated data and/or the text of the relevant passages.

Next, at operation 430, one or more potential passages are identified from the relevant passages based on a search for the query action pattern performed at operation 428. In some aspects at operation 430, the one or more potential passages identified are the passages within the relevant passages that have an action pattern that match the query action pattern. In some aspects, if no query action patterns are identified at operation 408, then the one or more potential passages identified at operation 430 are the same as the relevant passages identified at operation 426. In some aspects, if the identified query action patterns are not found in the relevant passages at operation 430, then the one or more potential passages identified at operation 430 are the same as the relevant passages identified at operation 426.

In some aspects, method 400 includes operation 432. If no nouns are identified at operation 408, method 400 does not include operation 432. If any nouns are identified at operation 408, method 400 includes operation 432. At operation 432, the annotated data and/or text of the one or more potential passages are searched for the one or more query nouns. In some aspects, the query nouns may be matched to nouns found in the annotated data and/or text of the one or more potential passages during the search for the query nouns at operation 432.

At operation 434 one or more result passages are identified from the one or more potential passages. If no query nouns are identified at operation 408, the one or more result passages will be the same as the one or more potential passages at operation 434. If query nouns are found in or matched to nouns in the annotated data and/or text of the one or more potential passages, the one or more result passages will be the passages within the one or more potential passages with nouns that match the query nouns at operation 432. Further, if the identified query nouns are not found in or matched to the nouns in the annotated data and/or text of the one or more potential passages at operation 434, the one or more result passages will be the same as the one or more potential passages at operation 434.

Next, at operation 436 the one or more result passages are provided to the user in response to the received query. In some aspects, the one or more result passages are provided to the user by sending instructions to a client computing device to provide the one or more result passages to the user in response to received query. The client computing device may provide the answer to the user via any known suitable output, such as voice output, image output, text output, video output, and/or etc. For example, the client computing device may display the natural language answer as text on a user interface at operation 436.

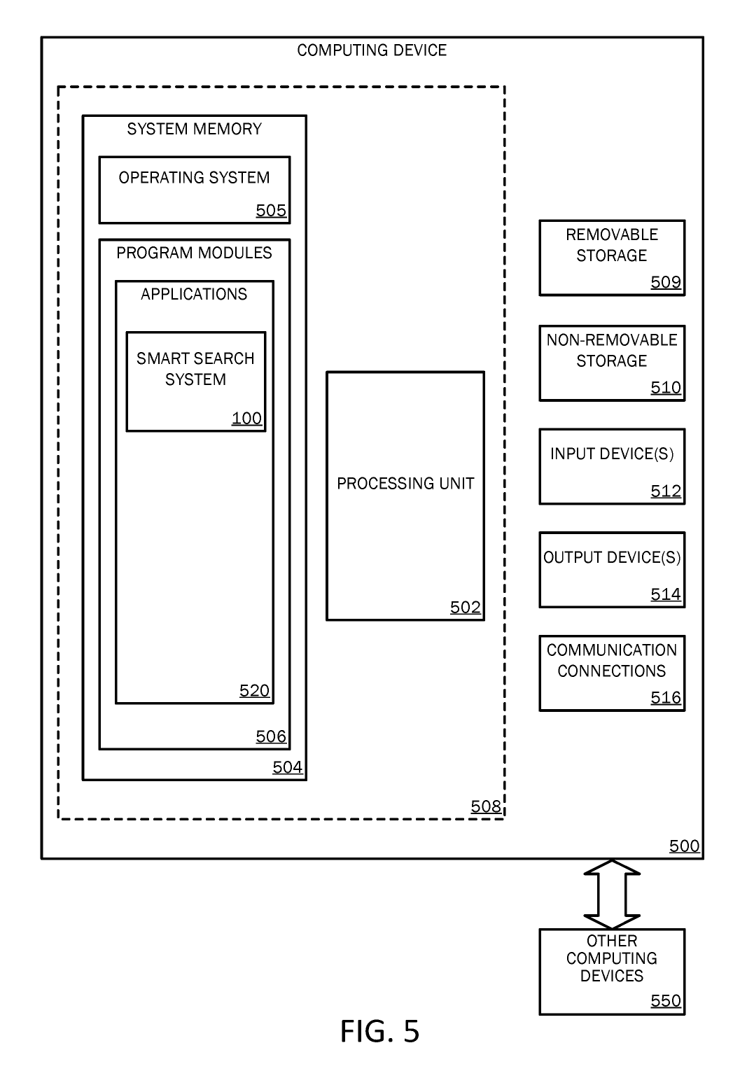

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. For example, smart search system 100 could be implemented by the computing device 500. In some aspects, the computing device 500 is a mobile telephone, a smart phone, a tablet, a phablet, a smart watch, a wearable computer, a personal computer, a desktop computer, a gaming system, a laptop computer, and/or etc. The computing device components described below may include computer executable instructions for smart search system 100 that can be executed to employ method 400 to for smart searching of an electronic document, such as ebook, in response to received user query.

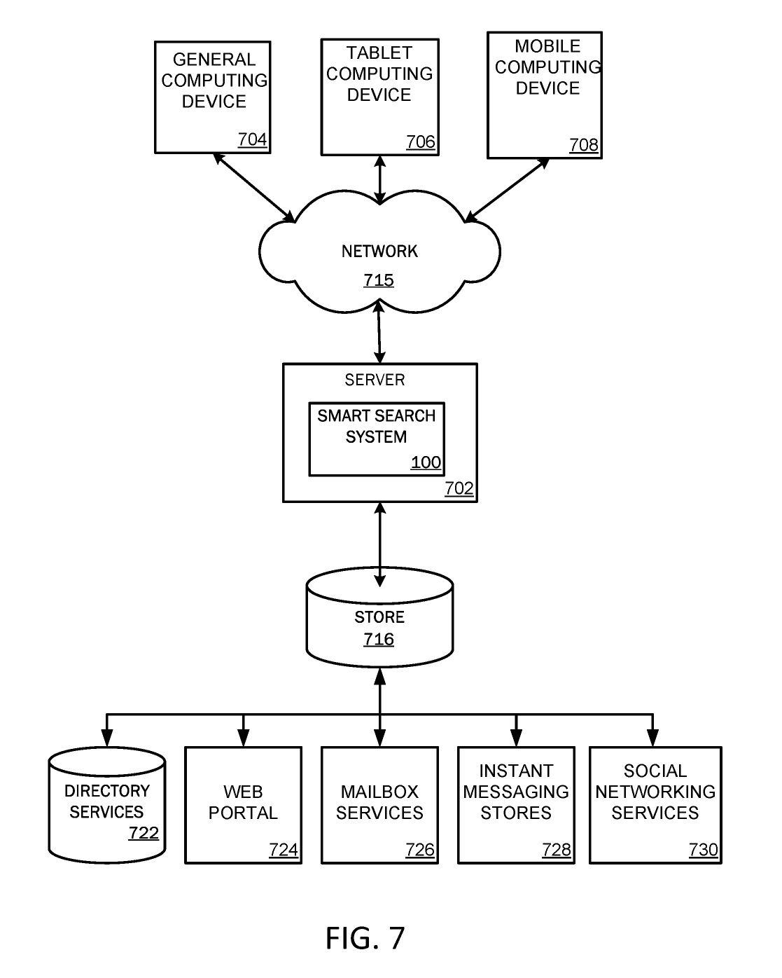

In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combined of such memories. The system memory 504 may include an operating system 505 and one or more program modules 506 suitable for running software applications 520. The operating system 505, for example, may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 7 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., smart search system 100) may perform processes including, but not limited to, performing method 400 as described herein. For example, the processing unit 502 may implement smart search system 100. Other program modules that may be used in accordance with aspects of the present disclosure, and in particular to generate screen content, may include a digital assistant application, a voice recognition application, an email application, a social networking application, a collaboration application, an enterprise management application, a messaging application, a word processing application, a spreadsheet application, a database application, a presentation application, a contacts application, a gaming application, an e-commerce application, an e-business application, a transactional application, exchange application, a device control application, a web interface application, a calendaring application, etc. In some aspect, smart search system 100 is utilizes to search for information within electronic documents generated by the above list of applications.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip).

Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 500 may also have one or more input device(s) 512 such as a keyboard, a mouse, a pen, a microphone or other sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, RF transmitter, receiver, and/or transceiver circuitry, universal serial bus (USB), parallel, and/or serial ports.

The term computer readable media or storage media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

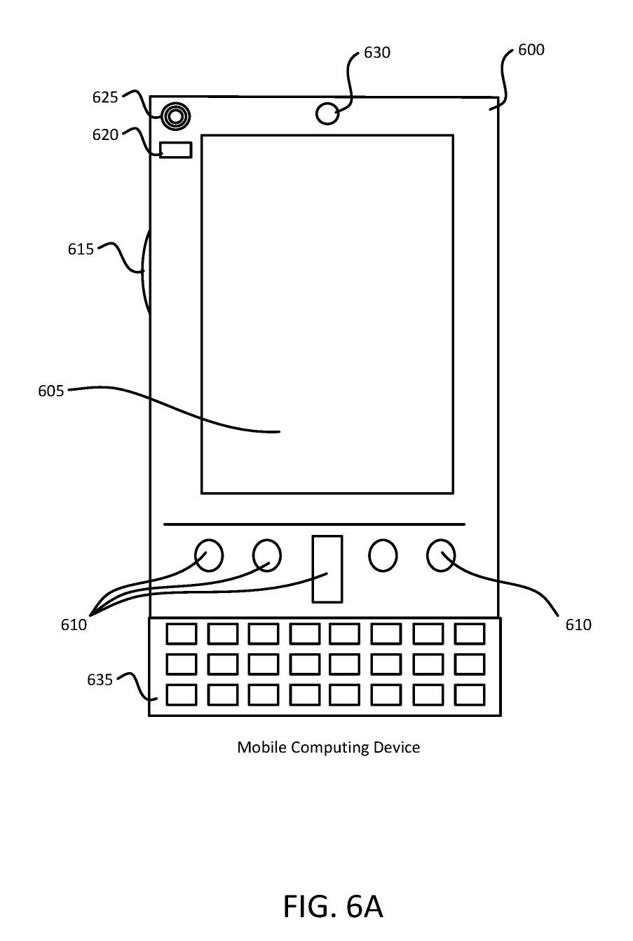

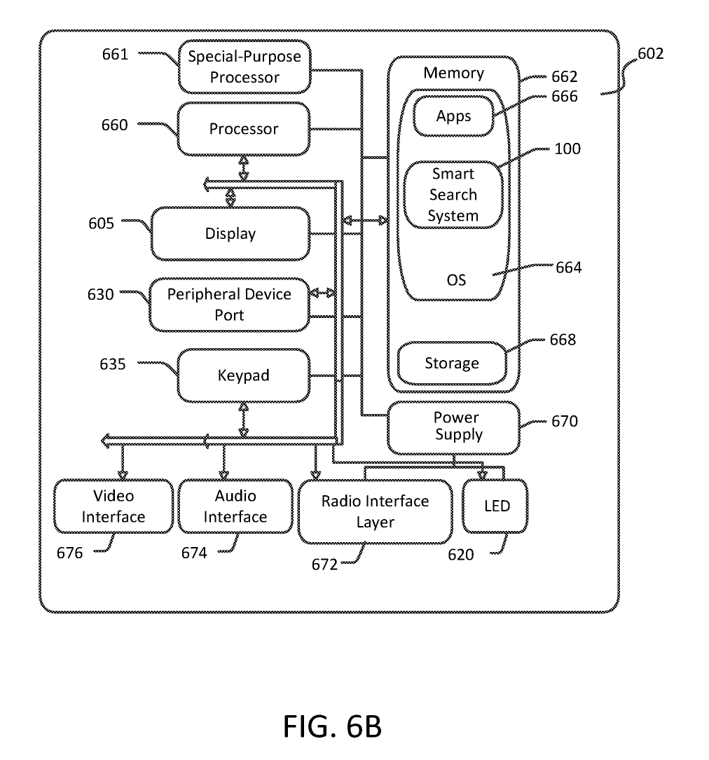

FIGS. 6A and 6B illustrate a mobile computing device 600, for example, a mobile telephone, a smart phone, a tablet, a phablet, a smart watch, a wearable computer, a personal computer, a desktop computer, a gaming system, a laptop computer, or the like, with which aspects of the disclosure may be practiced. With reference to FIG. 6A, one aspect of a mobile computing device 600 suitable for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some aspects. In yet another alternative aspect, the mobile computing device 600 is a portable phone system, such as a cellular phone. The mobile computing device 600 may also include an optional keypad 635. Optional keypad 635 may be a physical keypad or a “soft” keypad generated on the touch screen display.

In addition to, or in place of a touch screen input device associated with the display 605 and/or the keypad 635, a Natural User Interface (NUI) may be incorporated in the mobile computing device 600. As used herein, a NUI includes as any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence.

In various aspects, the output elements include the display 605 for showing a graphical user interface (GUI). In aspects disclosed herein, the various user information collections could be displayed on the display 605. Further output elements may include a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one aspect, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666, smart search system 100 runs on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated aspect, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

FIG. 7 illustrates one aspect of the architecture of a system for processing data received at a computing system from a remote source, such as a general computing device 704, tablet 706, or mobile device 708, as described above. Content displayed and/or utilized at server device 702 may be stored in different communication channels or other storage types. For example, various documents may be stored using a directory service 722, a web portal 724, a mailbox service 726, an instant messaging store 728, and/or a social networking site 730. By way of example, smart search system 100 may be implemented in a general computing device 704, a tablet computing device 706 and/or a mobile computing device 708 (e.g., a smart phone). In some aspects, the server 702 is configured to implement a smart search system 100, via the network 715 as illustrated in FIG. 7.

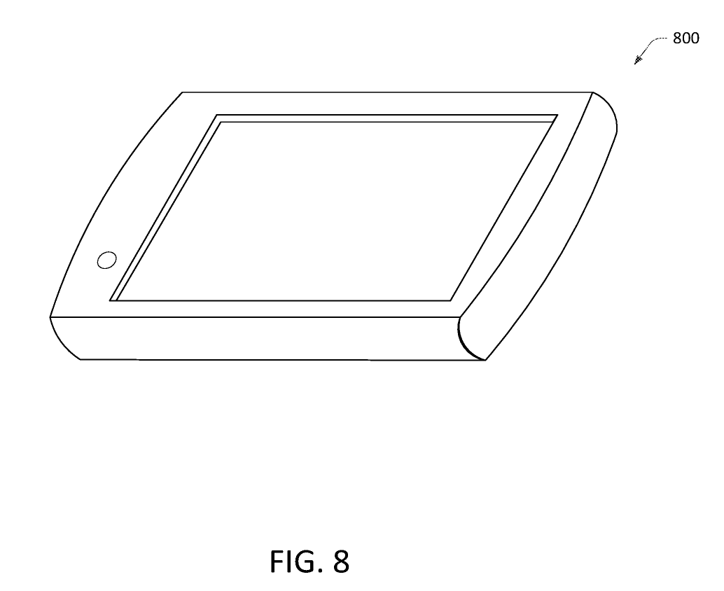

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Embodiments of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

This disclosure described some embodiments of the present technology with reference to the accompanying drawings, in which only some of the possible aspects were described. Other aspects can, however, be embodied in many different forms and the specific aspects disclosed herein should not be construed as limited to the various aspects of the disclosure set forth herein. Rather, these exemplary aspects were provided so that this disclosure was thorough and complete and fully conveyed the scope of the other possible aspects to those skilled in the art. For example, aspects of the various aspects disclosed herein may be modified and/or combined without departing from the scope of this disclosure.

Although specific aspects were described herein, the scope of the technology is not limited to those specific aspects. One skilled in the art will recognize other aspects or improvements that are within the scope and spirit of the present technology. Therefore, the specific structure, acts, or media are disclosed only as illustrative aspects. The scope of the technology is defined by the following claims and any equivalents therein.

1. A system for ebook smart searching, the system comprising:
at least one processor; and
a memory for storing and encoding computer executable instructions that, when executed by the at least one processor is operative to:
receive a notification of a loaded first ebook;
collect annotated data for the first ebook;
receive a first query for the first ebook;
parse the first query utilizing a knowledge graph and a dictionary to form a revised query, wherein parse the first query comprises:
identify elements in the first query,
identify a replaceable element in the elements,
replace the replaceable element with a corresponding collocation,
assign a context to at least one identified keyword in the first query,
wherein identified keywords include the corresponding collocation and remaining elements from the elements,
identify a query action pattern for the context, and
identify nouns in the first query;
search the annotated data and text of the first ebook for keywords that match the identified keywords;
identify one or more relevant passages based on the keywords in the ebook that match the identified keywords;
search the annotated data of the one or more relevant passages for any story action patterns that match the query action pattern;
identify one or more potential passages from the one or more relevant passages based on the story action patterns that match the query action pattern;
search for the nouns in the one or more potential passages;
determine one or more result passages based on the search for the nouns in the one or more potential passages; and
provide the one or more result passages to the user in response to the first query.

2. The system of claim 1, wherein the one or more result passages do not include any terms from the first query.

3. The system of claim 1, wherein the story action patterns in the one or more result passages are not a 100% match to the query action pattern.

4. The system of claim 3, wherein unstructured content in the story action patterns is disregarded as noise to match the query action pattern.

5. The system of claim 1, wherein the dictionary is updated based on the annotated data.

6. The system of claim 1, wherein the knowledge graph is updated based on the annotated data.

7. The system of claim 1, wherein the knowledge graph and the dictionary are updated based on the annotated data.

8. The system of claim 1, wherein the nouns are inferred in the revised query utilizing the knowledge graph.

9. The system of claim 1, wherein the at least one processor is operative to:
receive a notification of a loaded second ebook;
collect annotated data for the second ebook; and
receive a second query for the second ebook.

10. A system for ebook smart searching, the system comprising:
at least one processor; and
a memory for storing and encoding computer executable instructions that, when executed by the at least one processor is operative to:
receive a notification of a loaded ebook;
collect annotated data for the ebook;
receive a query for the ebook;
parse the query utilizing at least one of a knowledge graph and a dictionary to form a revised query, wherein parse the query comprises:
identify elements in the query,
identify replaceable elements in the elements,
replace the replaceable elements with collocations,
assign a context to at least one keyword of keywords in the query, and
identify a query action pattern for the context;
search the annotated data of the ebook for the keywords;
identify one or more relevant passages based on the search for the keywords;
search the annotated data of the one or more relevant passages for any story action patterns that match the query action pattern;
identify one or more potential passages from the one or more relevant passages based on the story action patterns that match the query action pattern;
identify one or more result passages from the one or more potential passages; and
provide the one or more result passages in response to the query.

11. The system of claim 10, wherein parse the query further comprises:
analyze the query to identify nouns.

12. The system of claim 11, wherein parse the query further comprises:
determine that there are no nouns in the query based on the analysis of the query to identify the nouns,
wherein the one or more result passages are the same as the one or more potential passages.

13. The system of claim 11, wherein parse the query further comprises:
identify one or more nouns in the query based on the analysis of the query to identify the nouns,
search for the nouns in the one or more potential passages;
identify the one or more result passages based on the search for the nouns in the one or more potential passages.

14. The system of claim 13, wherein the nouns are inferred from one or more keywords of the query utilizing the knowledge graph.

15. The system of claim 13, wherein no nouns are found in the one or more potential passages based on the analysis of the query to identify the nouns,
wherein the one or more result passages are the same as the one or more potential passages.

16. The system of claim 10, wherein the one or more result passages do not include any terms from the query.

17. The system of claim 16, wherein the story action patterns in the one or more result passages are not a 100% match to the query action pattern, and
wherein unstructured content in the story action patterns is disregarded as noise to match the query action pattern.

18. A method for electronic document smart searching, the method comprising:
receiving a notification of a loaded electronic document, wherein the electronic document contains at least a predetermined amount of data;
collecting annotated data for the electronic document;
receiving a query for the electronic document;
parsing the query utilizing a knowledge graph and a dictionary to form a revised query,
wherein parsing the query comprises utilizing dependency parsing and part-of-speech tagging;
identifying one or more relevant passages from the electronic document based on a search for keywords from the revised query;
searching the annotated data of the one or more relevant passages and identifying story action patterns that match a query action pattern from the revised query;
identifying one or more potential passages from the one or more relevant passages based on the story action patterns that match the query action pattern;
identifying one or more result passages from the one or more potential passages; and
sending the one or more result passages in response to the query.

19. The method of claim 18, wherein identifying the one or more result passages from the one or more potential passages comprises:
searching the annotated data of the one or more potential passages for nouns that match one or more query nouns from the revised query; and
identifying the one or more result passages from the one or more potential passages based on the nouns that match the one or more query nouns.

20. The method of claim 18, wherein the one or more result passages do not include any terms from the query.
